(19) United States
(12) Patent Application Publication
(10) Pub. No.: US 2015/0020617 A1
(43) Pub. Date: Jan. 22, 2015

(54) Sprocket-Driven Door

(71) Applicant: Rodney H. Neumann, The Woodlands, TX (US)

(72) Inventor: Rodney H. Neumann, The Woodlands, TX (US)

(21) Appl. No.: 13/946,177

(22) Filed: Jul. 19, 2013

(51) Int. Cl. F16H 19/04

(52) U.S. Cl. CPC F16H 19/04
USPC 74/30

(57) ABSTRACT

Where access doors are used for pets, poultry, farm animals, traps, or human access, this invention describes a drive mechanism for moving the door. The access door panel could be applied to a cage, house, coop, trap, feed receptacle, or other application. The drive mechanism of the automatic door is described here as a sprocket that directly engages with the movable door panel. Manufacture of the sprocket and door panel is such that can be punched from raw sheet metal and not requiring precision milling processes. The function provides opening and closing by sliding or swiveling the door panel. Holding the door panel in place is an important additional function of the direct drive mechanism of this invention.

### BACKGROUND OF INVENTION

Embodiments of this invention comprise a drive mechanism that slides open and slides closed a door panel by direct coupling with a sprocket, driven by a gear-motor. The door panel is the structure that moves so as to allow entry or to close-off entry of a door opening. The direct coupling of the sprocket with the door panel is through a series of holes formed in the door panel. These holes in the door panel, for engaging with the sprocket, are herein referred to as sprocket holes.

In the case of an access door for farm animals or for pets, it is desired that the door panel be positively held shut or open without extra latches. Embodiments of this invention lock the door panel position to the gear-motor so that the door panel cannot be moved except by the turning of the gear-motor. There are many means that may accomplish this but this presentation describes simple and effective solutions.

In the case of chicken coop doors, the door panel itself may be a flap that opens upward or opens sideways like a regular household door, or it might slide sideways or up and down. A preferred door configuration in this embodiment is the up and down style or call it a guillotine style. The guillotine style embodiment comprises much of this presentation but this invention is not restricted to that style of configuration.

In contrast to a common method of accomplishing an automatic door mechanism, the door might be linked to the drive motor through strings or belts and pulleys. In cases of using a string to pull the door open, the door may use gravity as the means of closing the door. Only the weight of the door is provided as a means of keeping the door closed against the attempts of an animal trying to open the door. In much of the prior art, the weight of the door, being desired to not be too heavy so not to have to employ much power to open the door is a trade-off with being heavy enough to impede an animal from getting through.

Prior methods that may use a string or belt to open the door may also use a separate locking mechanism that latches the door closed instead of relying on the weight of the door to impede access. The extra locking or latching mechanism adds complexity and is subject to fail

Other methods may also use levers and gears and may do so in a way that locks the door position to the motor. If the motor is a gear-motor with a worm-gear or in some way the motor cannot be turned by prying the door, one of these methods may well accomplish holding the door open or shut without extra latching mechanisms.

However, these methods require extra components, such as a gear that meshes with teeth on another member that then applies force directly or indirectly to the door. Alternately, the motor might operate a pulley that applies a non-slipping belt that terminates at another pulley and the door is attached in some way to the belt assembly.

Another method that likewise makes it difficult for the door to be pried open is a screw-drive. A screw is a relatively costly component, such as one milled with so-called ACME thread. Also, the screw is likely to be gummed up with debris especially if it is lubricated and this may be very likely in some environments such as in a chicken coop. The location of the motor to drive the screw, and the fact the screw must not stand in the door opening, are reasons this method can lead to a much taller or longer door assembly than what is possible with embodiments of the present invention.

While embodiments of this invention may be similar to long standing prior art called rack-and-pinion, contrasting with such prior art mechanisms is the fact the meshing surfaces of the rack-and-pinion must be precision milled to fit. The rack is a separate costly component that must be mated or coupled to the door panel. The pinion is also a precision milled component. Besides the costly difference between manufacture by stamping sheet metal versus milling solid metal pieces, the number of components also makes the rack-and-pinion inferior for this application.

In the cases of both the prior art precision milled methods such as screw-drive or rack-and-pinion, the grease attracts dirt and the dirt meshes with the rubbing components which may eventually require maintenance for cleaning or cause failure if not attended. With embodiments of this invention, debris tends to fall out rather than become entrained in the meshing of the sprocket with the sprocket holes.

The prior art methods use multiple components to couple the motor to the door. Embodiments of this invention's driven motivator have only one component, a sprocket, and the other component is the door itself and does not require intermediate coupling. This simplicity leads to improvement in cost, maintenance, and reliability.

Another embodiment of this invention where the sprocket holes are distributed in an arc allows for a swiveling door panel instead of one that moves in a straight line, which is simple to accomplish by this method whereas not straight forward with a lead-screw or rack-and-pinion.

Embodiments of this invention are directly applicable to use in access doors, and especially the likes of pet doors or farm animal doors that are automatically operated and particularly in the case of this inventor's application: chicken coop automatic doors.

Upon realization of this simple mechanism of embodiments of this invention, the manufacturer and user would both enjoy advantage of reliable operation and reduced cost to manufacture and still be able to achieve a door that stays closed. These described driving methods feature impediment to prying the door open.

### BRIEF DESCRIPTION OF INVENTION

This invention consists of embodiments where a door panel slides open and closed, horizontally or vertically in a linear motion and embodiments also where the motion is not linear. Rather than the door panel sliding in a straight line, a useful embodiment of this invention includes where the door panel slides in an arc. If the door panel swivels on a pivot and the sprocket holes are placed in an arc, since no more than three teeth of the sprocket engage in the sprocket holes at one time, this embodiment is preferred in applications of limited space around the door.

Vertically, the door might slide similar to a guillotine. Horizontally, it might lay flat to cover a feed trough or lay flat on a wall. The drive motor provides the motive power to move the door, and with the unique feature of a series of holes made directly into the material of the door panel itself to allow a sprocket on the motor shaft to slide the door open and closed.

Electronic control of the motor is performed by switching voltage polarity to the motor for either clockwise or counterclockwise turning of the sprocket, and by electronically shorting the motor terminals together for braking caused by back-EMF. By electronic braking, the movable door panel resists being moved by outside forces. The drive mechanism, by staying engaged with the door panel, and with sufficient gear-ratio in the gear-motor gearbox, has leverage advantage against outside forces in either direction.

### DETAILED DESCRIPTION OF INVENTION

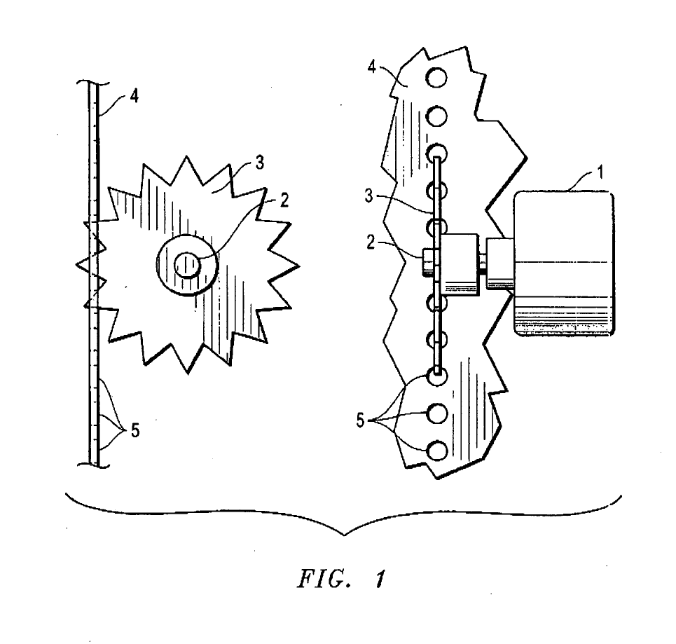

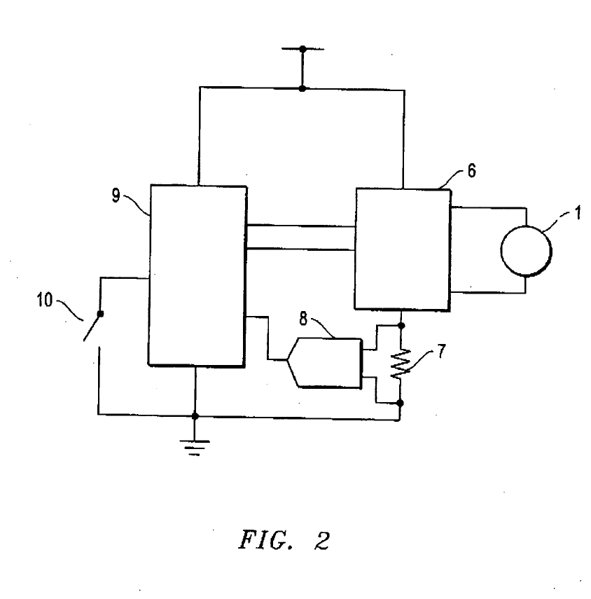

To aid in the description of this invention, drawings are given in the form of two figures:
Description of FIG. 1: The sprocket is rigidly connected to the shaft of a gear motor and the sprocket teeth engage in holes that are aptly spaced and integral to the door.
Description of FIG. 2: The electronic circuit that shows the motor current is sampled through a resistor, the voltage across which indicates the motor load, for purposes of detection of end of travel.

The following text makes reference to parts of the drawings, summarized in this table.

| Reference | |
|---|---|
| Numeral | Name of Part |
| 1 | Gear-motor |
| 2 | Motor Shaft |
| 3 | Sprocket |
| 4 | Sliding Door |
| 5 | Sprocket holes in door |
| 6 | Electronic H-Bridge switch |
| 7 | Current sensing resistor |
| 8 | Analog to digital converter |
| 9 | Microcontroller |
| 10 | Limit switch |

The motor is a gear-motor 1 which is a DC electrical motor with a rotating shaft 2. The sprocket 3 is a gear with relatively narrow or pointed teeth or even pointed cylinders sticking out radially, and it has a hub that allows it to be rigidly engaged with the shaft 2. The door 4 slides back and forth or up and down and has a series of holes in it: the so-called sprocket holes 5 that are directly fabricated as part of the door itself, such as drilled or punched holes in the door.

The H-bridge switch 6 is made up of four switches in an “H” pattern where minimally the switch ON/OFF combinations consists of: All four OFF; Two switches ON in order to short the motor windings out; Two switches ON to allow current through the motor in one direction; Two switches ON to allow current through the motor in the other direction. Hazardous combinations of switch ON/OFF conditions must be avoided so that current cannot shoot through the H-bridge from rail to rail.

In the preferred embodiment, the H-bridge switch 6 is solid-state and electronically controlled. It could also be relay contact switches, electronically controlled. The switch arrangement applies DC electricity to the motor by switching two wires, one to plus and other to minus, or vice-versa, or neither (OFF). Preferably the H-bridge has built-in protection against shoot-through hazard either self-contained in an H-bridge component, or via software control in the microcontroller. The current sensing resistor 7 is merely a low resistance that the motor current passes through. The analog to digital converter 8 takes analog voltage in and registers an equivalent digital value as output. The microcomputer 9 is a single chip that executes the program that provides the automatic functionality. The limit switch 10 could be a physical switch contact, or any other kind of switch that senses that the door is at the desired end-of travel. Besides a contact, the switch could be an eddy current sensor, magnetic sensor such a permanent magnet and reed switch, or magnet and hall-effect, or an optical switch.

The gear-motor 1 is provided to turn the sprocket 3 with the required torque at the desired speed to accomplish the door opening and closing function, given the door load. The sprocket is rigidly connected to the motor shaft 2.

The sprocket 2 is designed and the holes 5 provided in the door 4 are fabricated such that the sprocket meshes properly with the holes in the door.

The size of the sprocket holes 5 and tolerances dictate what range of hole-spacing is required. A nominal hole-spacing will infer a sprocket pitch, or distance between points, for a given sprocket diameter.

The gear-motor is of such design that the shaft rotates at relatively low speed. The desired speed depends upon how fast is desired that the door is moved. It is desirable for an animal door to operate slowly enough for the animal to react if the door closes upon him.

The circumference of the sprocket times the rotational speed of the shaft gives the linear speed of the door. If the sprocket is 1″ in diameter and the rotational speed of the motor is 10 RPM, then the linear speed is approximately 3 inches per 1/10 minute or ½ inch per second.

The interplay of sprocket hole-size and hole-spacing, relative to the sprocket design for desired speed and given the weight of the door, all needs to be worked out in a given design by a person skilled to do so.

The DC electrical power to the gear-motor is electronically switched through an H-bridge switch 6. The amount of current through the motor passes through current sensing resistor 7 which provides a voltage drop. The voltage dropped across the current sensing resistor is measured by the microcontroller 9 through an analog to digital convertor 8. Alternatively, the voltage could be processed with a comparator instead of or in addition to an analog to digital convertor.

When the sensed current increases rapidly, the microcomputer program can use that information to affect the switch 6 to turn off the motor or change its direction, since sudden increase in current indicates end-of-travel. The sensed current might also be compared against a normal current to see if excessive current signals end-of-travel or some other obstacle. Optionally, a limit switch 10 can be used to sense the end-of-travel so that the gear-motor is not routinely bound up every time the door reaches the end. Then motor stall and gear wind-up will be less often occurring and would tend to mostly signal an obstruction or faulty limit switch.

The edges of the teeth of the sprocket preferably are linear and triangle-shaped. Common gears are complex in topology in that the gears mesh together to transfer load one to the other via a point of contact that slides over the surfaces of the gear-teeth. The same is true for a precision-machined rack and pinion. These components are of complex surface shape where the gear and the rack mate to transfer load. In the case of this invention, the gear or sprocket is very simple because it mates not with another gear or precision formed component, but rather simply with a row of holes.

At any instant in time, the load of the door is transferred to the sprocket at the point of contact between the linear surface of the sprocket tooth and the inside of the hole punched in the door. When lifting the door, the load of the door on the upper tooth that carried the door upward, is transferred to the next tooth just below it so that the upper tooth can pull out of the sprocket hole in the door. If the lower tooth did not unload the upper tooth, the upper tooth would hook on the sprocket hole and the mechanism would bind. The edge of the sprocket, the face that slides along the inside of the sprocket hole, we will use the term “flank”.

The preferred embodiment is that the sprocket be punched out of the same sheet metal type of material as the door itself. Their hardness and characteristics should be the same or nearly so. The material should be a hard material, such as steel or galvanized steel, and only due to the requirement that the door operates less frequently and not continuously, can it be trusted that the sprocket and sprocket holes do not wear detrimentally to the functionality. Other materials such as stainless steel or softer materials such as aluminum or brass or even polymer materials, could be made to function well as alternative embodiments of this invention. Some materials could be cast molded or formed, especially plastic materials, and would still be part of the described invention.

The spacing of the holes in the door should be equal, or nearly equal, to spacing of the teeth, not at the root and not at the crest, but in between. We could use the terminology:
Major Diameter: Diameter of the sprocket at the crests of the teeth.
Pitch Diameter: Diameter of the sprocket at the mid-point of the teeth.
Minor Diameter: Diameter of the sprocket at the root of the teeth.

The spacing is not critical but ideally the penetration of the teeth into the sprocket holes in the door should have a designed distance where it should be expected that tolerance be allowed, as the distance from the door to the sprocket can vary dynamically and in manufacture variation. The dimension preferred then is at the pitch diameter of the sprocket to allow for maximum error in either the sprocket being too close or too far from the door.

The door's sprocket holes can be round or rectangular, but round is preferred as it tends to keep the door aligned down the middle of the track of holes. Sprocket holes shaped such that the gear stays centered in the sprocket hole and thereby centering the door panel in its tracks are preferred over rectangular holes. If not rounded, such self-centering holes might be triangular-shaped or trapezoidal-shaped and fit the description of preferred versus the less-preferred rectangular shape.

The motor mounting should be spaced rigidly from the door to achieve the described penetration. The motor torque should be specified so that the motor has no trouble opening the door. Especially in the case of a guillotine door, the weight of the door is likely the major part of the load on the motor.

The motor torque is amplified by the gear train by the total ratio N and yet reduced by a factor due to efficiency e in the gear train. The maximum load of the door is the weight of the door plus friction.

Simple calculations yield the amount of power required to lift the load of a vertical sliding door in such an embodiment. Horizontal embodiments have mostly just the frictional component to the load while swivel embodiments where sprocket holes align in an arc, have a lifting load that has a vector that resolves by simple trigonometry. In any of the embodiments, the additional use of polymer tape between the sliding door elements may be employed to reduce the frictional component and the force of the sprocket against the door can add to the normal force considered in the F=un, the coefficient of friction being u and n being the normal force, to yield the friction force F. Other frictional reduction methods can be employed in embodiments so as to help performance and need to be included in these calculations.

To illustrate the calculations, a lifting or vertical configuration can be utilized here. Assume the pitch diameter of the sprocket is 24 mm and the weight of the door panel is 1 Kg while the friction load is an additional 1 Kg. Let us assume a loaded motor speed of 3500 RPM and a desired rate of opening as 24 mm per second as we want a 300 mm tall door opening to be opened in 12.5 seconds. Let us assume the efficiency e of the gears and the motor, from shaft load to motor electrical power is e=0.33.

The power at the shaft is 300 mm*2 Kg/12.5 seconds=0.048 Kg*m/sec. Since in this example the efficiency e=0.33, the power at the electrical terminals required is 0.144 Kg*m/s.

Since 1 kg-m/s is equal to 9.8 Watts, this gives 1.4 electrical Watts to lift the door in 12.5 seconds. Also, since the circumference of the sprocket at the load point at the pitch diameter of 24 mm, is pi*12 mm, or 75 mm, and since 300 mm/75 mm=4, it takes 4 shaft rotations to open the door. Further, in 60 seconds, that would be 60/12.5=4.8 times the four rotations in one minute or 19.2 RPM. Given the motor RPM is 3500, the desired gear ratio is about 180.

The motor specification would be a nominal 1.4 Watt motor with nominal 3500 RPM loaded at a motor shaft torque of 3*180 times the sprocket shaft torque. If the shaft is 6 mm diameter, the torque on the shaft is four times the torque at the pitch diameter. So that is 2 Kg*24 mm/6 mm=8 Kg*mm. So 8 Kg*mm torque, or 800 g*cm, divided by 3*180=1.48 g*cm. The motor itself must have at least 1.48 g*cm torque.

Assuming the motor voltage is 5 volts, and given 1.4 Watts, that implies the motor current is 280 mA under this load. If the current sampling resistor is 0.5 ohm, we can expect a voltage drop of 0.14 volts during the nominally loaded operation of the door. If the door is obstructed at the end of travel or due to an obstacle, the motor will stall and current could go to several times this much. If we set the threshold at 2.5 times this maximum load, or 0.700 Amps, the current resistor voltage will be at least 0.35 volts if the motor stalls.

While the door is parked in position and it is not desired that it move farther, the H-bridge can be controlled by the microcontroller to apply brakes to the motor. The so-called back-EMF of a motor is well known and can be used to brake the motor by simply shorting the motor terminals together. Electronically, to stop the motor and to park the motor, the microcontroller should apply the signals to the H-bridge switch that produces a low resistance path between the motor terminals. This could be to operate the switches such that both motor terminals are at the bottom voltage rail potential or both at the high rail potential; either case will make the motor difficult to turn. Looking through 200:1 turns ratio (N=200) makes it 200 times as hard to turn, save for the caveat that the gearbox has torque limitations. Even to preserve battery power, if the microcontroller is put to sleep to reduce energy consumption, the output port pins can be set for motor braking without costing battery life.

Microcontrollers with built-in comparators and/or built-in analog to digital converters lend themselves well to one skilled in the art to apply these subsystems to the described functional pieces of this invention.

An automatic door, where the coupling between the door and the motor is elastic, is inferior because the door can be pried open. Embodiments of this invention use rigid coupling which makes it possible to use back-EMF motor braking in concert with the high gear ratio, to reduce the possibility of prying open the door.

Embodiments of this invention take advantage of simplicity and low-cost of making the mechanism out of stamping out the sprocket and door on CNC sheet metal punch equipment. Whether produced with a custom machined punch and die or produced by an automatic sequence of operations with standard shaped punches, the resulting sprocket is equivalent. The sprocket could have nominally 16 teeth and the teeth can be made by an auto-stepping feature on the automatic punch machine or CNC punch machine that punches in a sequence dictated by the CNC program. The automatic sequence that rotates a rectangular or square punch tool as it steps around in a circle is an efficient method of manufacturing the sprocket. The dimensions for the teeth may turn out to be some odd angles and lengths on the teeth, but the preferred method is to compromise by making the teeth with a square punch. In the case of 16 teeth, the step rotation would be 22.5 degrees per step and would be executed on the Pitch Diameter circumference at 22.5 degree steps around the circle. The sprocket holes can be rectangular, elliptical, or circular. The circular or elliptical choices lead to the sprocket seeking the center of the hole, which helps minimize side to side wiggle in the door. A rectangular hole tends to allow the teeth to slide to one end or the other of the slotted hole which puts the next tooth in danger of binding if it does not hit on the hole.

Any embodiment that uses a track of holes for a sprocket to drive a sliding door panel is claimed in this invention. While it is preferred that the track holes be made directly in the side, bent edge or face of the door, a component with sprocket holes rigidly connected to the moveable door panel would alternatively suffice as being part of this invention.

The angle at which the sprocket or gear mates with the door is also an alternate method but still the same; if the motor shaft is parallel to the door or is perpendicular to the door, but drives the door through a gear sprocket directly to the door, that is the same invention. The alternative not claimed here is a rack and pinion where precision machined surfaces are utilized as mating driving elements.

Another embodiment where the door panel is made of flexible material with a series of holes made in the door panel, the door can flex and turn 90 degrees to turn out of the way as it opens. This embodiment is otherwise the same as other embodiments specified herein that it comprises a door with a sprocket that directly drives the door panel.

This application claims the priority date of U.S. provisional patent application No. 61673301 entitled “Sprocket Drive Door” which was filed Jul. 19, 2012.

I claim:

1. A drive mechanism comprising:
A sprocket with at least eight sprocket teeth, rigidly attached to a shaft turned by a gear-motor and a movable door panel where the sprocket teeth are engaged in a series of sprocket holes in the movable door panel.

2. The mechanism of claim 1 wherein the sprocket holes in the movable door panel are round where the sprocket teeth contact the movable door panel.

3. The mechanism of claim 1 wherein the shaft protrudes directly out of and is an integral part of the gear-motor.

4. The mechanism of claim 1 wherein the sprocket is manufactured by an automatic punch machine that punches the sprocket from a sheet of material by making a sequence of rectangular holes each aligned on the circumference of the sprocket, turning the punch tool each step by the amount of angle necessary to make the teeth with given angular separation.

5. The mechanism of 1 wherein the sprocket teeth are triangular.

6. The mechanism of claim 1 wherein the sprocket holes in the door panel are round holes.

7. The mechanism of claim 1 wherein the sprocket engaged with the door panel couples a force between the moveable door panel and the sprocket through the contact of no more than three sprocket teeth at a time.

8. The mechanism of claim 1 wherein the sprocket is punched from a sheet using a custom-machined punch and die.

9. The mechanism of claim 1 wherein the gear-motor has a DC motor including electrical polarity control affecting the direction of motor rotation.

10. The mechanism of claim 1 wherein the gear-motor current is monitored electronically to produce a signal used to stop the motor or reverse motor direction.

11. The mechanism of claim 1 wherein the electronic control of the gear-motor includes electrically connecting nominally-zero resistance directly across the motor terminals in order for the motor to resist door motion.

12. The mechanism of claim 1 wherein the sprocket holes in the movable door panel are distributed in a straight line.

13. The mechanism of claim 1 wherein the sprocket holes in the movable door panel are on the face of the movable door panel.

14. The mechanism of claim 1 wherein the sprocket holes in the movable door panel are on the bent edge of the movable door panel.

15. The mechanism of claim 1 wherein the sprocket holes in the movable door panel are distributed in an arc.
